(19) United States
(12) Patent Application Publication
(10) Pub. No.: US 2007/0017276 A1
(43) Pub. Date: Jan. 25, 2007

(54) Resonant structure humidity sensor

(76) Inventors: William R. Trutna JR., Atherton, CA (US); Richard C. Ruby, Menlo Park, CA (US); Storrs T. Hoen, Brisbane, CA (US); Annette C. Grot, Cupertino, CA (US); Mark A. Unkrich, Emerald Hills, CA (US); Graham Flower, San Jose, CA (US); John Stephen Kofol, Sunnyvale, CA (US)

Correspondence Address: AVAGO TECHNOLOGIES, LTD., P.O. BOX 1920, DENVER, CO, 80201-1920, US

(21) Appl. No.: 11/185,406

(22) Filed: Jul. 20, 2005

(51) Int. Cl. G01N 7/00

(52) U.S. Cl. 73/29.01

(57) ABSTRACT

A humidity sensor that includes a resonant structure and a structure for altering a resonant frequency of the resonant structure in response to a change in humidity. The structures of a humidity sensor according to the present teachings may be formed in relatively small form factors and are well suited to remote applications and providing mechanisms for compensating for temperature drift.

### BACKGROUND

Humidity sensors may be employed in a wide variety of applications. Example applications for humidity sensors include heating and air conditioning systems. In addition, humidity sensors may be used in process control systems, weather stations, agricultural environments, etc.

A humidity sensor may include a humidity sensitive capacitor that changes its capacitance in response to changes in humidity. For example, a humidity sensitive capacitor may include a water permeable dielectric material sandwiched between two metal plates. The metal plates may have holes that allow water to reach the dielectric material. An increase in humidity may cause the dielectric material to absorb water. The water absorbed by the dielectric material increases the dielectric constant of the dielectric material which increases the capacitance of the capacitor.

Unfortunately, a humidity sensor that employs a humidity sensitive capacitor may not be suitable for many applications. For example, humidity sensitive capacitors and associated circuitry may be too bulky for many applications. In addition, prior humidity sensors may be subject to temperature drift.

### SUMMARY OF THE INVENTION

A humidity sensor is disclosed that includes a resonant structure and a structure for altering a resonant frequency of the resonant structure in response to a change in humidity. The structures of a humidity sensor according to the present teachings may be formed in relatively small form factors and are well suited to remote applications and providing mechanisms for compensating for temperature drift.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a humidity sensor according to the present teachings;

FIG. 2 shows a resonant structure in one embodiment;

FIG. 3 shows a humidity sensor including circuitry for measuring a resonant frequency of a resonant structure;

FIG. 4 shows a humidity sensor having a temperature compensation circuit according to the present teachings.

### DETAILED DESCRIPTION

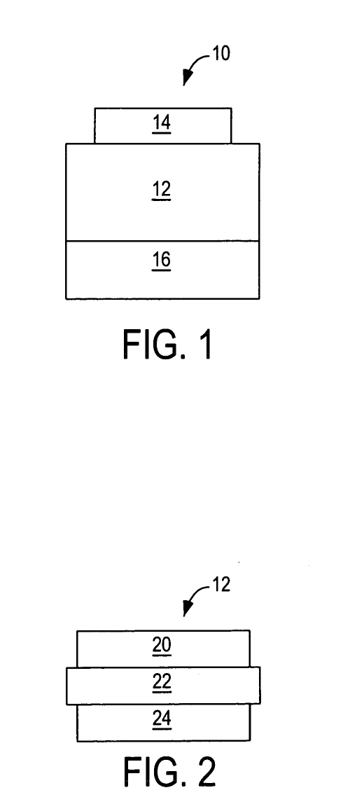

FIG. 1 shows a humidity sensor 10 according to the present teachings. The humidity sensor 10 includes a resonant structure 12 and a structure 14 for altering a resonant frequency of the resonant structure 12 in response to a change in humidity. The resonant structure 12 and the structure 14 in one embodiment are disposed on a substrate 16.

The mass of the structure 14 is responsive to changes in humidity. The mass of the structure 14 provides a mass loading onto the resonant structure 12 that influences the resonant frequency of the resonant structure 12. An increase in the mass of the structure 14 decreases the resonant frequency of the resonant structure 12 whereas a decrease in the mass of the structure 14 increases the resonant frequency of the resonant structure 12. As a consequence, the resonant frequency of the resonant structure 12 provides an indication of humidity.

In one embodiment, the structure 14 includes a material that is permeable to water. An increase in humidity causes the structure 14 to absorb more water and increase its mass whereas a decrease in humidity causes the structure 14 to release water and decrease its mass. As a consequence, an increase in humidity is reflected in a decrease in the resonant frequency of the resonant structure 12 whereas a decrease in humidity is reflected as an increase in the resonant frequency of the resonant structure 12.

The structure 14 may be a water absorbing polymer material. One example of a water absorbing polymer material is dimethyl siloxane. Other example materials for the structure 14 include the following water sensitive polymers—4-vinyl phenol, N-vinyl pyrrolidone, ethylene oxide, and caprolactone.

The structure 14 may be disposed onto the resonant structure 12 in a solution, e.g. by paint, by spin coating, by dipping, or by photolithographic patterning, to name a few examples. The resonant structure 12 may be formed using photolithographic patterning.

FIG. 2 shows the resonant structure 12 in one embodiment. The resonant structure 12 in this example is a thin film bulk acoustic resonator (FBAR) structure. The FBAR structure includes a pair of metal structures 20 and 24 and an intervening membrane structure 22.

The membrane structure 22 resonates in response to an acoustic wave having a wavelength of approximately one-half the thickness of the membrane structure 22. The resonant frequency of the membrane structure 22 may be in the range of 0.6 to 8 Ghz depending on the thickness of the membrane structure 22. The mass of the structure 14 alters the resonant frequency of the membrane structure 22 in response to changes in humidity.

The metal structures 20 and 24 may be aluminum. The membrane structure 22 may be aluminum-nitride.

The FBAR structure in one embodiment is approximately 200 microns in diameter. The thickness of the FBAR structure may be between 2 and 3 microns.

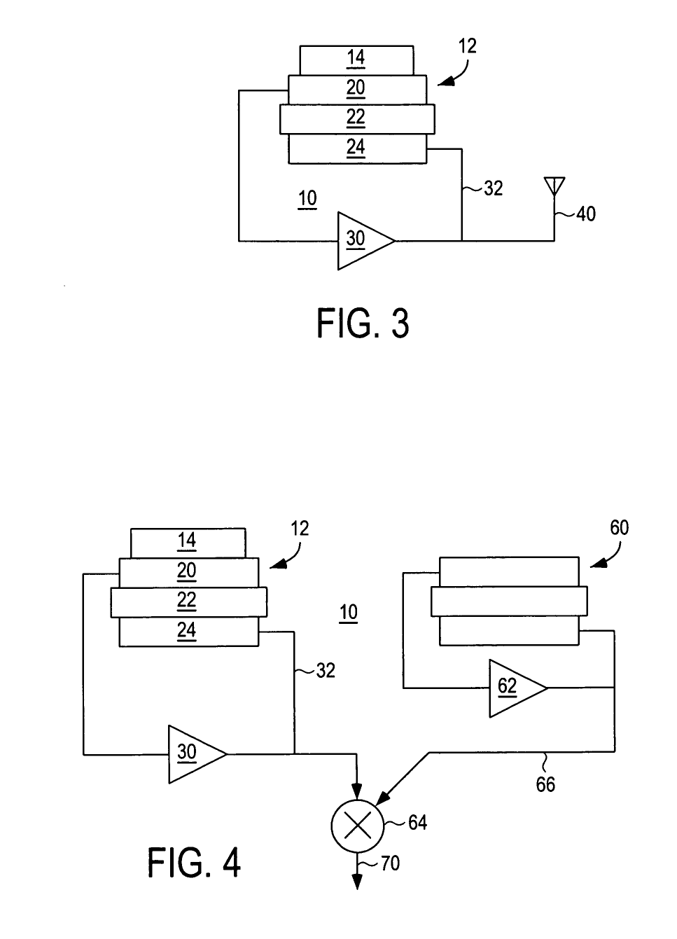

FIG. 3 shows an embodiment of the humidity sensor 10 including circuitry for measuring humidity by measuring the resonant frequency of the resonant structure 12. The circuit for measuring the resonant frequency of the resonant structure 12 uses the resonant structure 12 as a filter element in an oscillator. The resonant structure 12 is placed in a feedback loop of an amplifier 30. The piezoelectric effect from resonant vibration of the resonant structure 12 causes oscillation at an output 32 of the amplifier 30. The electrical signal at the output 32 has a frequency that depends on the resonant frequency of the resonant structure 12. As a consequence, the frequency of the electrical signal at the output 32 indicates the changes to the mechanical loading of the structure 14 on the resonant structure 12 in response to changes in humidity.

In the embodiment shown, the electrical signal at the output 32 drives an antenna 40. The frequency of an over the air signal from the antenna 40 indicates the humidity sensed in the humidity sensor 10. The signal from the antenna 40 may be received at a remote site for remote humidity sensing applications. The RF resonant frequencies associated with an FBAR structure are particularly well suited to over the air remote sensing.

Alternatively, the electrical signal at the output 32 may be provided to a signal processing circuit (not shown). The signal processing circuit may compute a humidity figure in response to the frequency of the electrical signal at the output 32.

FIG. 4 shows an embodiment of the humidity sensor 10 having a temperature compensation circuit. The temperature compensation circuit includes a resonant structure 60, an amplifier 62, and a mixer 64. The temperature compensation circuit subtracts out the common mode temperature drift in the resonant structures 12 and 60.

The resonant frequency of the resonant structure 60 tracks the resonant frequency of the resonant structure 12 with temperature changes. In one embodiment, the resonant structure 60 is an FBAR structure that is substantially similar to an FBAR structure of the resonant structure 12. For example, the FBAR structures may have substantially similar metal structures and membrane structures, i.e. same materials and dimensions, and may be formed on the same substrate and be subject to the same changes in temperature.

The resonant structure 60 is placed in a feedback loop of the amplifier 62 and the electrical signal at an output 66 of the amplifier 62 has a frequency that depends on the resonant frequency of the resonant structure 62. The mixer 64 generates a difference signal 70 that indicates a difference in the frequencies of the electrical signals at the outputs 32 and 66 of the amplifiers 30 and 62, i.e. a difference in the in the resonant frequencies of the resonant structures 12 and 62. The difference signal 70 may drive an antenna or may be provided to a signal processing circuit as previously described.

Alternatively, the output signals 32 and 60 may be transmitted via an antenna to a remote site and the difference in the frequencies may be determined at the remote site.

In one embodiment, the FBAR structure of the resonant structure 60 and the FBAR structure of the resonant structure 12 are each approximately 200 microns in diameter with a thickness between 2 and 3 microns. The two FBAR structures with bonding pads may be placed on a die about 0.5 mm by 0.5 mm.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A humidity sensor, comprising:
resonant structure;
structure for altering a resonant frequency of the resonant structure in response to a change in humidity.

2. The humidity sensor of claim 1, wherein the structure for altering is selected to provide mass loading of the resonant structure.

3. The humidity sensor of claim 1, wherein the structure for altering comprises a water sensitive polymer material.

4. The humidity sensor of claim 1, wherein the structure for altering comprises a material selected from among dimethyl siloxane, 4-vinyl phenol, N-vinyl pyrrolidone, ethylene oxide, and caprolactone.

5. The humidity sensor of claim 1, wherein the resonant structure comprises an FBAR structure.

6. The humidity sensor of claim 1, further comprising a circuit for measuring humidity by measuring the resonant frequency of the resonant structure.

7. The humidity sensor of claim 6, further comprising an antenna for transmitting at the resonant frequency.

8. The humidity sensor of claim 6, further comprising a temperature compensation circuit.

9. The humidity sensor of claim 8, wherein the temperature compensation circuit comprises:
second resonant structure;
circuit for measuring a resonant frequency of the second resonant structure;
circuit for determining a difference in the resonant frequencies.

10. The humidity sensor of claim 9, further comprising an antenna for transmitting at the difference in the resonant frequencies.

11. A method for providing a humidity sensor, comprising:
forming a resonant structure;
forming a structure for altering a resonant frequency of the resonant structure in response to a change in humidity.

12. The method of claim 11, wherein forming a structure for altering includes forming a structure that provides mass loading onto the resonant structure.

13. The method of claim 11, wherein forming a structure for altering includes forming a water sensitive polymer material.

14. The method of claim 11, wherein forming a structure for altering includes forming a structure using a material selected from among dimethyl siloxane, 4-vinyl phenol, N-vinyl pyrrolidone, ethylene oxide, and caprolactone.

15. The method of claim 11, wherein forming a resonant structure includes forming an FBAR structure.

16. The method of claim 11, further comprising measuring humidity by measuring a resonant frequency of the resonant structure.

17. The method of claim 16, further comprising transmitting at the resonant frequency.

18. The method of claim 16, further comprising compensating for a temperature drift of the resonant structure.

19. The method of claim 18, wherein compensating comprises:
forming second resonant structure;
measuring a resonant frequency of the second resonant structure;
determining a difference in the resonant frequencies.

20. The method of claim 19, further comprising transmitting at the difference in the resonant frequencies.
